(19) United States
(12) Patent Application Publication
(10) Pub. No.: US 2005/0256258 A1
(43) Pub. Date: Nov. 17, 2005

(54) PVB Film for Composite Safety Glass and Composite Safety Glass

(76) Inventor: Uwe KELLER, Siegburg (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/492,307

(22) PCT Filed: Oct. 10, 2002
(86) PCT No.: PCT/DE02/03817

§ 371 Date: Oct. 18, 2004

(30) Foreign Application Priority Data
Oct. 11, 2001 (DE) 101 50 091.2

(51) Int. Cl. B32B 17/10

(52) U.S. Cl. 524/557; 428/442; 524/145

(57) ABSTRACT

Composite glass with films based on partially acetalated polyvinyl alcohol containing a softening agent, especially PVB based, as an intermediate layer with magnesium salts or calcium salts of organic acids as an adhesion-reducing additive (anti-adhesive agent) exhibit large amounts of fluctions with regard to adhesion when the composite glass is subjected to thermal stress. According to the invention, phosphorous compounds are used, selected from the group consisting of organophosphites i.e. esters of phosphorinic acid with organic radicals, organophosphates, i.e. esters of orthonophosphoric acid, as an additive which during further processing compensates for fluctations in adhesion in films based on partially acetalated polyvinyl alcohol containing a softening agent. The invention is used in the production of films for the manufacture of safety glass, especially used in the building and automotive industry.

### TECHNICAL FIELD

The invention relates to a plasticized film composed of partially acetalized polyvinyl alcohols as intermediate layer in laminated safety glass.

Laminated safety panes, composed of two glass panes and of an adhesive film composed of partially acetalized polyvinyl alcohols, preferably of polyvinyl butyral (PVB), and bonding the glass panes are in particular used as windshields in motor vehicles, where, if appropriate, one glass pane may have been replaced by a plastics pane, mainly composed of an amorphous polyamide, transparent PMMA, polycarbonate, or polyester. Silicate glass/silicate glass or silicate glass/plastics laminates of this type are also used in the construction sector, e.g. as windowpanes or as partition walls, and, if appropriate and depending on the use of the laminates, e.g. as bulletproof glass, use is also made of multiple laminates, i.e. laminates which are composed of more than two load-bearing layers.

As is known, the safety properties of laminated glass with a polyvinyl butyral film (PVB film) depend on the adhesion between film and glass. If the adhesion is very high, although the glass fragments are sure to adhere to the film in the event of mechanical failure of the laminated glass—e.g. through exposure to impact—thus preventing the separation of sharp-edged glass splinters, it is relatively easy for an impacting object to penetrate the laminated glass, because the strong adhesion of the PVB film to the glass is such that the film can undergo very little elastic deformation at the impact point, and therefore also contributes only little to the deceleration of the object. If the adhesion to the glass is lower, the PVB film can deform and separate from the glass when subjected to tensile stress at the impact point, the result being deceleration of the impacting object.

The plasticizers for PVB which are used commercially in conventional PVB films comprise mainly aliphatic diesters of tri- or tetraethylene glycol. Among these are 3GH, 3G7, and also 4G7, in all of which the prefixed numeral refers to the number n of the oligoethylene glycol repeat unit H—(O—CH₂—CH₂)ₙ—OH, and H refers to 2-ethylbutyrate, 7 refers to n-heptanoate, and 8 refers to 2-ethylhexanoate. Among other known plasticizers for polyvinyl butyral are dialkyl adipates having aliphatic or cycloaliphatic ester residues, dialkyl sebacates, triorganophosphates, triorganophosphites, or phthalate plasticizers, such as benzyl butyl phthalate.

Since, on the other hand, excessively low adhesion makes it easier for glass fragments to separate from the PVB film, and thus increases the risk of injury to persons, particular industrial applications aim at a compromise between high and low adhesion, i.e. moderate adhesion, in order to comply with both requirements—splinter binding and penetration resistance—to the maximum extent. This applies in particular in the case of laminated safety panes for vehicles, whereas laminated safety panes for the construction sector are often intended to have relatively high adhesion between glass and adhesive film.

### PRIOR ART

For the controlled lowering of adhesion of PVB film to glass, use has long been made of the salts of alkali, or alkaline earth, metals with organic acids, for example in the form of hydroxides, salts, or complexes, these being added in small amounts to the formulation during the production of PVB films (DE 15 96 902 B, DE 15 96 894 B, U.S. Pat. No. 3,249,488 A, U.S. Pat. No. 3,249,489 A, U.S. Pat. No. 3,262,835 A, U.S. Pat. No. 3,262,836 A). However, alkali metal salts, e.g. potassium acetate or potassium formate, exhibit marked disadvantages in relation to the weathering resistance of open edges of the laminated safety glass. Many salts have pronounced hygroscopic properties, and this promotes an increase in the concentration of ingressive water at the PVB film/glass boundary, thus reducing the adhesion in the edge region of the laminated safety glass to the extent that the film can separate from the glass. Furthermore, alkali metal salts cause a visually unattractive white clouding of the PVB film at the points where it has exposure to water.

Salts of alkaline earth metals do not exhibit these disadvantages, and it therefore appears desirable to use these as antiadhesive agents. However, in combination with certain plasticizers these have the disadvantage that the adhesion to the glass can be dependent on the thermal stress placed on the laminated safety glass. Variations in the adhesion can therefore arise, depending on the profile of pressure and of temperature in the autoclave process, the temperature and duration of which can vary between one further processor and another, and between one production assembly and another. In particular in the case of laminated glass production in the conventional autoclave process, adhesion can suddenly fall away sharply on long exposure to a high processing temperature, sometimes to zero under extreme processing conditions. This phenomenon is particularly observed when using certain plasticizers, namely glycol esters composed of oligoethylene glycols and of linear carboxylic acids, in combination with alkaline earth metal salts as antiadhesive agents.

DE 24 10 153 C3 discloses a process for adjusting the adhesion of plasticized partially acetalized polyvinyl alcohols using silanes having silicon functions and having organosilicon functions, where the silanes having silicon functions reduce adhesion and the silanes having organosilicon functions increase adhesion.

However, depending on the process conditions, the result of adding silane compounds is occasional local crosslinking of the resin used, this crosslinking being difficult to control, and thus formation of visible nodules.

U.S. Pat. No. 3,841,955 A1 describes the use of organophosphates, e.g. tri-2-ethylhexyl phosphate, as plasticizers in a mixture with another nonphosphate plasticizer. The amounts used are stated as more than 20% of the plasticizer mixture. No mention is made of any effect on the adhesion of the PVB film.

U.S. Pat. No. 4,681,810 A1 proposes the use of organophosphates in PVB film to provide self-extinguishing properties in the event of a fire. Organic phosphate is used because it has specific carbonizing properties, and phosphites are used because they have “sequestering” properties. The selection of the amount of organophosphates is such that it is a main constituent of the film. No mention is made of any effect on the adhesion of the PVB film.

U.S. Pat. No. 3,950,305 A1 describes the use of esters of phosphorous acid (phosphites) in a mixture with phenolic antioxidants with the aim of increasing the heat resistance of the PVB. The evaluation here uses yellowing due to ingress of oxygen and increased temperature, and the torque curve in kneading tests. No mention is made of any possible effect on the adhesion of the PVB film. The minimum content of phosphite in the formulation for a film for a laminated safety glass is stated as 0.6% by weight, based on the PVB used.

It is a well-known phenomenon that one and the same glass pane can give different adhesion to the tin side and to the fire side, using one and the same PVB film, but it is regarded as ideal for this difference to be minimized. This difference is attributable to the different chemical composition of the two surfaces of float glass, the side known as the tin side—the side which in the float glass process is in contact with the liquid tin—being tin-doped in the finished product. However, despite the difference between the two sides of the glass, and also despite the frequently encountered quality variations between batches and between producers, the adhesion of a PVB film optimized for constant adhesion should be independent of the orientation of the glass, and this means that the adhesion on the fire side should be as nearly as possible identical with the adhesion on the tin side.

### OBJECT

It is an object of the present invention to provide a film based on plasticized partially acetalized polyvinyl alcohol for use as intermediate layer in laminated safety glass, which, on the one hand, has as uniform as possible adhesion to, respectively, the tin side and the fire side in a laminate with float glass, and which, on the other hand, gives uniform adhesion under different conditions of further processing. A further object of the invention is to provide a laminate, encompassing at least one silicate glass pane, and also a film based on plasticized partially acetalized polyvinyl alcohol, which complies with these conditions.

It is a further object of the invention to eliminate adhesion decreases in the finished laminated safety glass of more than 2.5 pummel units, as defined hereinafter, even on exposure to extreme temperatures.

### SUMMARY OF THE INVENTION

Surprisingly, it has now been found that alkaline earth metal salts of organic acids in combination with certain phosphorus compounds can establish stable adhesion which is less susceptible to thermal degradation. Although the initial effect of addition of the phosphorus compounds is to increase adhesion to the glass, counter measures via an increase in the amount of alkaline earth metal salts or organic acids establish relatively stable overall adhesion at the level originally desired with a pummel value of from ≧1.5 and ≦8.

Among the inventive phosphorus compounds are organophosphites, i.e. triesters of phosphorous acid with organic residues, and also organophosphates, i.e. triesters of orthophosphoric acid with organic residues.

These may in particular be symmetrical or asymmetrical alkyl phosphites, or symmetrical or asymmetrical alkyl phosphates, symmetrical meaning that each of the three organic substituents linked by way of an oxygen atom to the phosphorus are identical, whereas in the case of asymmetrical types at least two of the three substituents differ from each other.

The compounds may also be symmetrical or asymmetrical alkylaryl phosphites or symmetrical or asymmetrical alkylaryl phosphates, symmetrical or asymmetrical aryl phosphites or symmetrical or asymmetrical aryl phosphates, or, respectively, mixed phosphites or, respectively, phosphates, which contain not only aryl substituents but also alkyl substituents. In all cases, it is also possible for there to be more than one phosphite or, respectively, phosphate unit linked chemically via one or more organic radicals.

Examples of symmetrical alkyl phosphites are trilauryl phosphite or tristearyl phosphite.

An example which may be used for symmetrical alkylaryl phosphates is tris(2,4-di-tert-butylphenyl) phosphite (obtainable, for example, as ALKANOX® from Great Lakes Chemical Corporation) or tris(nonylphenyl) phosphite (obtainable, for example, as IRGAFOS® TNPP from Ciba).

An example which may be used for a symmetrical aryl phosphite is triphenyl phosphite (obtainable, for example, as IRGAFOS® TPP from Ciba).

An example which may be used for a mixed phosphite which contains not only aryl substituents but also alkyl substituents is diphenyl octyl phosphite.

IRGAFOS® P-EPQ from Ciba is a phosphite in which more than one phosphite unit is linked chemically via an organic radical.

According to the invention, the film comprises not only the partially acetalized polyvinyl alcohol and a plasticizer, but also an adhesion-reducing additive in the form of alkaline earth metal salts of organic acids. Use is made here of a magnesium salt and/or a potassium salt of organic acids. The amount to be used of the adhesion-reducing alkaline earth metal salt of organic acids depends on the PVB resin used, on the plasticizer, and on the desired pummel value, and is moreover dependent on the organophosphite or organophosphate used. The amount needed in practice therefore has to be determined via simple experiments. It is generally from 0.001 to 0.25% by weight, based on the entire film mixture. The preferred amount of alkaline earth metal salts of organic acids is from 0.01 to 0.1% by weight if 3G8 (triethylene glycol di-2-ethylhexanoate) is used as plasticizer, from 0.005 to 0.05% by weight if 3G7 (triethylene glycol n-heptanoate) is used as plasticizer, and from 0.005 to 0.05% by weight if DHA (di-n-hexyl adipate) is used, based in each case on the entire film mixture.

The plasticized partially acetalized polyvinyl alcohol resin preferably comprises from 25 to 45 parts by weight, and particularly preferably from 30 to 40 parts by weight, of plasticizer, based on 100 parts by weight of resin.

The partially acetalized polyvinyl alcohols are prepared in a known manner via acetalization of hydrolyzed polyvinyl esters. Examples of aldehydes which may be used are formaldehyde, acetaldehyde, propionaldehyde, butyraldehyde, and the like, preferably butyraldehyde. The preferred polyvinyl butyral resin contains from 10 to 25% by weight, preferably from 17 to 23% by weight, and particularly preferably from 19 to 21% by weight, of vinyl alcohol residues. The polyvinyl butyral also contains, if appropriate, from 0 to 20% by weight, preferably from 0.5 to 2.5% by weight, of acetate residues.

The water content of the films is preferably adjusted to 0.15-0.8% by weight, in particular to 0.3-0.5% by weight.

To test the adhesion of films based on plasticized partially acetalized polyvinyl alcohol, and to check the action of antiadhesive agents, use is made of what is known as a pummel test, certain variants of which are described in the literature. A precisely defined, reproducible pummel test is described below, so that the level of assessment can be adequate for comparative purposes and for quantitative measurements. Wherever the description or the claims refer to a pummel test, this means a test defined as follows:

Pummel Test

To test adhesion between a PVB film and glass, the film is laminated, using two panes of float glass of thickness 2.1 mm (PLANILUX®). A test specimen with dimensions 8×30 cm is cut from the resultant laminated safety glass. This specimen is aged for at least 24 h in a freezer at −18° C. (±2° C.). The cooled test specimen is removed from the freezer and immediately “pummeled”, the specimen being conducted at a uniform rate underneath a hammer head which delivers blows of a precise position (weight 500 g, round head, energy of each hammer blow 1 Nm), in such a way as to give about 75% overlap between one hammer blow and the next (FIG. 1). As shown in FIG. 1, the first blow has to make contact with a corner of the test specimen, and after that a complete row transverse to the test specimen is traversed—symbolized by arrow 1 in FIG. 1—and only when this process is complete is the adjacent row—symbolized by arrow 2) in FIG. 1, which then runs at a greater distance from the edge, to be “pummeled” in the opposite direction, until all of the glass to a distance of at least 6 cm, measured from the edge, has been shattered and possibly separated from the film. During this procedure, the test specimen must always lie flat with an angle of 5° with respect to a steel support mounted at an angle of 45° . The first hammer blow in the first row is indicated by A in FIG. 1, and the final blow in the second row is indicated by Z.

After completion of this procedure, the specimen is lightly tapped in order to remove any loose glass splinters. For quantitative determination of the pummel value, a visual determination is made of the proportion of film surface exposed, and of the proportion still covered by glass particles. The assessment takes place at room temperature. For assessment of intermediate grades, the specimen is observed under incident light, and the amount of exposed film surface is determined visually. The detailed description of the pummel test procedure in the dissertation “A comparative analysis of PVB/glass laminate adhesion tests”; by Kristin Leah Kidd; University of Mass.—Lowell; 1993 may be utilized for supplementary information. Table 1 below is the basis to be used for evaluating the test specimen after the test, and for allocating a number, which is the pummel value. These pummel values are from 0 to 10, depending on the amount of exposed film surface.

The evaluation may award intermediate grades of 0.5 pummel units. However, the limited accuracy of the measurement means that finer differentiation is not sensible.

Table 1:

TABLE 1
Pummel scale definition

| Amount of exposed film | |
|---|---|
| surface in % | Pummel value |
| Separation of large-area | −1 |
| sections of glass | |
| 100 | 0 |
| 99 | 1 |
| 97 | 2 |
| 92 | 3 |
| 83 | 4 |
| 67 | 5 |
| 43 | 6 |
| 20 | 7 |
| 8 | 8 |
| 1 | 9 |
| 0 | 10 |

The pummel value −1 is given to laminated glass for which continuation of the pummel test becomes pointless because the first hammer blows lead to separation of large-area glass sections, due to almost total lack of adhesion.

The Δ pummel tests described below are carried out in order to demonstrate that inventive PVB films with reduced adhesion have more heat-resistance than a film which comprises the same PVB resin and the same plasticizer in the same mixing ratio, and has been adjusted to comparable adhesion, using an antiadhesive agent. 3 variants are used to simulate heat stress, namely a standard autoclave process, additional aging at an elevated temperature, and a long autoclave process, as can be used in an extreme case of industrial manufacture of laminated safety glass. Since the adhesion reduction in the PVB films of the prior art—if it occurs—does not always take place with the same rapidity, this being, inter alia, a function of formulation, laminate production method, type of glass and pretreatment of glass, and orientation of the glass with respect to the film, the evaluation is in each case based on the worst result from the 3 thermal stress variants, i.e. on the largest absolute reduction in the pummel value result, irrespective of whether it occurs on the fire side or on the tin side.

The 3 thermal stress variants are to be carried out as follows: the PVB films are first bonded in a standard autoclave process—as described hereinafter—using 2.1 mm glass. For “heat-aging” thermal stress, a test specimen is then aged for 72 h at 125° C., vertically positioned in a heating cabinet. For the variant 3 “long autoclave process” thermal stress, the PVB films with 2 panes composed of 2.1 mm float glass are combined in one of the usual processes, e.g. the roll process, to give a pre-laminate, which is then adhesive-bonded in a long autoclave process—as described hereinafter—to give the final laminate.

Standard Autoclave Process

The pre-laminates produced by one of the conventional processes known to the person skilled in the art, and composed of two panes of glass and of the PVB film to be tested, are placed in a pressure autoclave, e.g. from the producer “Scholz”, designed for the production of laminated safety glass, where they are secured vertically or approximately vertically on a suitable stand. The autoclave is designed so that temperature and pressure can be regulated independently of one another and can be kept constant over a prolonged period. A pressure/temperature program is run which lasts 90 min in total, and is defined here as a function of time (start: 0 min, end: 90 min): starting from ambient temperature (about 20° C.), the internal autoclave temperature reaches the maximum temperature of 140° C. after 30 min, and this temperature then remains constant until 60 min, i.e. for 30 min From 60 min to 90 min, the internal autoclave temperature is reduced from 140° C. to 40° C.

Starting from atmospheric pressure, the pressure is increased by 12 bar until 20 min and kept constant at this value until 80 min, and is then reduced back to atmospheric pressure by 90 min, i.e. by the end of the autoclave process. All of the changes in the parameters of pressure and temperature here are to be made continuously, thus having a ramped heating and pressure curve. FIG. 2 gives a graphic representation of the standard autoclave process.

Long Autoclave Process

The pre-laminates produced by one of the conventional processes known to the person skilled in the art, and composed of two panes of glass and of the PVB film to be tested, are placed in a pressure autoclave, e.g. from the producer “Scholz”, designed for the production of laminated safety glass, where they are secured vertically or approximately vertically on a suitable stand. The autoclave is designed so that temperature and pressure can be regulated independently of one another and can be kept constant over a prolonged period. A pressure/temperature program is run which lasts 330 min in total, and is defined here as a function of time (start: 0 min, end: 330 min): starting from ambient temperature (about 20° C.), the internal autoclave temperature reaches the maximum temperature of 140° C. after 30 min, and this temperature then remains constant until 300 min, i.e. for 270 min. From 300 min to 320 min, the internal autoclave temperature is reduced from 140° C. to 40° C., where it is held for the remaining 10 min of the process.

Starting from atmospheric pressure, the pressure is increased by 12 bar until 10 min and kept constant at this value until 320 min, and is then reduced back to atmospheric pressure by 330 min, i.e. by the end of the autoclave process. All of the changes in the parameters of pressure and temperature here are to be made continuously, thus having a ramped heating and pressure curve. FIG. 3 gives a graphic representation of the long autoclave process.

Heat-Aging

For “heat-aging” thermal stress, a test specimen is first produced by the standard autoclave process and is then aged for 72 h at 125° C., positioned vertically in a heating cabinet.

Determination of Δ Pummel Values

6 individual pummel tests are carried out, in each case two (fire side and tin side) for a laminate sample from the standard autoclave process, for a laminate sample from the long autoclave process, and for a laminate sample from the 72 h of heat-aging, and then a comparison is made of the pummel value for the fire side from the standard autoclave process with the other two pummel values for the fire side of the heat-stressed laminate samples, and the absolute value is determined for the greatest difference of the measured pummel values. This maximum difference of the measured pummel values for a film is the Δ pummel value for the fire side. The same procedure is to be followed for the tin side, and the maximum difference of the measured pummel values for the tin side for a film is then the Δ pummel value for the tin side. The larger Δ pummel value of the two is then the “maximum Δ pummel value” for a film. This should be as small as possible, and always smaller than or equal to 2.5. Values of 3 or more lead to adhesion variations beyond acceptable limits. According to the invention, the absolute value for all 6 of the measured pummel values is in the range ≧1.5 and ≦8.

In another, unexpected, effect found with the inventive addition of organophosphites or organophosphates, adhesion on each of the two glass surfaces, i.e. the fire side and the tin side, varies very little, and differences which are otherwise usual on the two sides are therefore reduced.

To produce the PVB films of the examples, the PVB powder is conveyed into the feed section of an extruder, where it is combined with the plasticizer, in which the UV absorber, the antiadhesive agent, and the organophosphorus compound, and also, if desired, other additives have been dispersed beforehand as homogeneously as possible, and is converted into a homogeneous melt which is extruded through a slot die to give a film web.

### BRIEF DESCRIPTION OF THE DRAWING

The invention is described in more detail below, using an example and the drawing, in which:

FIG. 1 is a graphic illustrating the pummel test

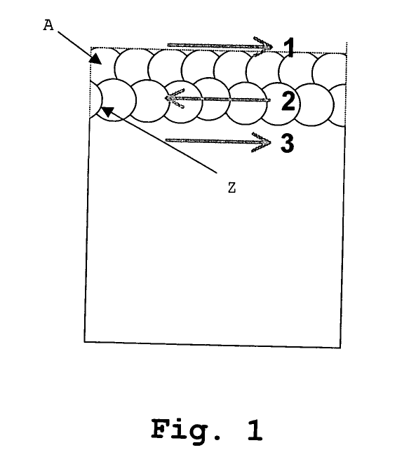

FIG. 2 is a graphic showing the standard autoclave process

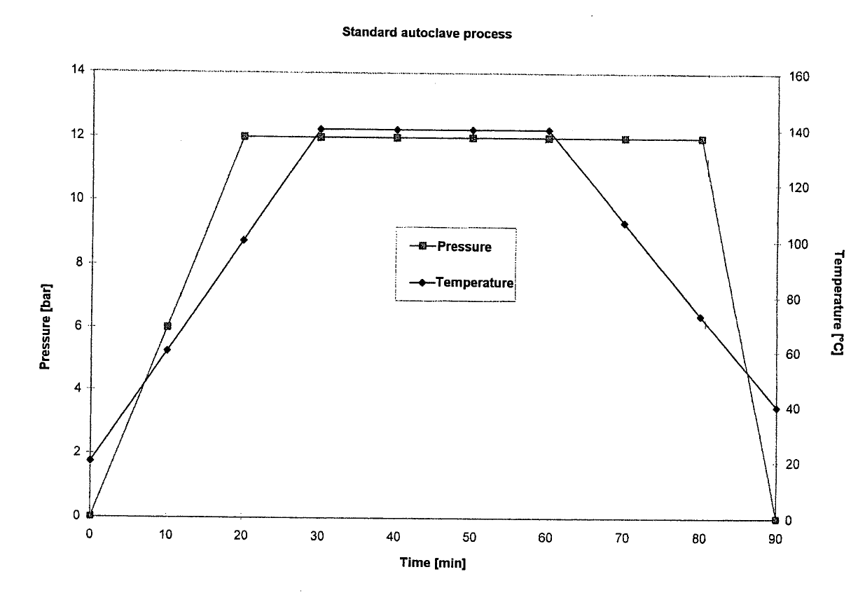

FIG. 3 is a graphic showing the long autoclave process

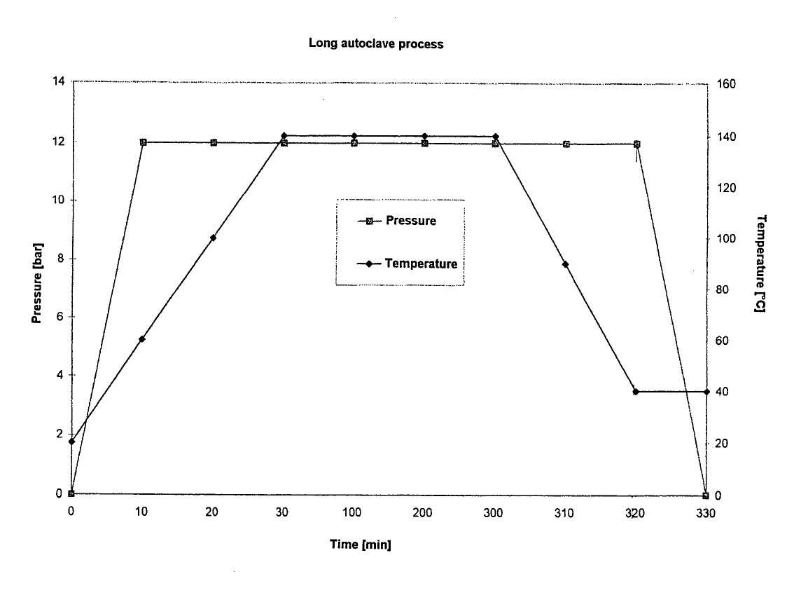

### METHODS OF IMPLEMENTING THE INVENTION AND COMPARATIVE EXAMPLES

For the Inventive Examples 1, 5 and 7, and also the Comparative Examples 2 to 4 and 6, all of which are listed below and shown in Table 2, films of thickness 0.76 mm were first produced in the manner known per se to the person skilled in the art, as in EP 0 185 863 B1. To this end, a mixture of commercially available PVB (Mowital® LP B 68/1 SF from Clariant) was homogenized and melted with plasticizer which is likewise commercially available, namely 3G7 in Experiments 1 to 5 and DHA in Experiments 6 and 7, in a single-screw extruder, with a throughput of 160 kg/h, and extruded through a slot tool. After appropriate conditioning, all of the films had the same water content of 0.47% by weight.

In Example 1, 0.04% by weight of a 30% strength magnesium octanoate solution were added as antiadhesive agent to the parent mixture of 74% by weight of PVB and 26% by weight of the plasticizer 3G7, i.e. 0.12 g of magnesium octanoate were used for 1 kg of film mixture. 0.15% by weight of the organophosphite Alkanox® TNPP were added to provide consistency of pummel values. As is seen in Table 2, the pummel values measured after the standard autoclave process were 5.5 on the fire side and 5 on the tin side. The pummel values resulting from the long autoclave process, as defined above, were 4 on the fire side and likewise 4 on the tin side. After 72 h of heat-aging at 125° C., as defined above, the resultant pummel values were 3.5 on the fire side and 5 on the tin side. This gives a Δ pummel value of 2 for the fire side, a Δ pummel value of 1 on the tin side, and a maximum Δ pummel value of 2.

From Comparative Example 2 it is seen that, without the inventive added organophosphite, firstly, and despite the smaller amount of antiadhesive agent, 0.025% by weight of a 30% strength magnesium octate solution, the pummel values after the standard autoclave process are lower than the values in Example 1: 3.5 on the fire side and 3 on the tin side. However, each of the pummel values determined after the long autoclave process is now 0, indeed −1 and 0 after the heat-aging (see Table 2), the resultant Δ pummel values therefore being 4.5 for the fire side and 3 for the tin side. The maximum Δ pummel value of 4.5 leads to final product values beyond the limits of acceptability.

Comparative Example 3 used the same antiadhesive agent content of 0.04% by weight (of the 30% solution) as Example 1, and the resulting pummel values from all methods of measurement are too low for practical applications.

TABLE 2

| | 1 | 2 (com- | 3 (com- | 4 (com- | 5 | 6 (com- | 7 |
|---|---|---|---|---|---|---|---|
| Example No | (inv) | parison) | parison) | parison) | (inv) | parison) | (inv) |
| Polymer content: % by weight of PVB | 74 | 74 | 74 | 74 | 74 | 75.5 | 75.5 |
| Plasticizer: % by weight of DHA | — | — | — | — | — | 24.5 | 24.5 |
| Plasticizer: % by weight of 3G7 | 26 | 26 | 26 | 26 | 26 | — | — |
| Antiadhesive agent: % by weight of magne- | 0.04 | 0.025 | 0.04 | 0.015 | 0.05 | 0.02 | 0.08 |
| sium octanoate (30% strength solution) | | | | | | | |
| Organophosphite: % by weight of Alkanox ® | 0.15 | — | — | — | — | — | 0.15 |
| TNPP | | | | | | | |
| Organophosphite: % by weight of Irgafos ® | — | — | — | — | 0.08 | — | — |
| DDPP | | | | | | | |
| Properties of laminate after standard (90′) | | | | | | | |
| autoclave program | | | | | | | |
| Fire side pummel value | 5.5 | 3.5 | 1 | 6 | 6.5 | 3 | 3 |
| Tin side pummel value | 5 | 3 | 0 | 5 | 6 | 3.5 | 4 |
| Properties of laminate after long (330′) | | | | | | | |
| autoclave program | | | | | | | |
| Fire side pummel value | 4 | 0 | −1 | 1 | 5 | 0 | 3.5 |
| Tin side pummel value | 4 | 0 | 0 | 2.5 | 6 | 1.5 | 4 |
| Properties of laminate after heat-aging (72 h | | | | | | | |
| at 125° C.) | | | | | | | |
| Fire side pummel value | 3.5 | −1 | −1 | 0 | 5 | −1 | 2 |
| Tin side pummel value | 5 | 0 | −1 | 1 | 6.5 | 0.5 | 5 |
| Evaluation | | | | | | | |
| Δ Pummel value, fire side | 2 | 4.5 | 2 | 6 | 1.5 | 4 | 1 |
| Δ Pummel value, tin side | 1 | 3 | 1 | 4 | 0.5 | 3 | 1 |
| Maximum Δ pummel value | 2 | 4.5 | 2 | 6 | 1.5 | 4 | 1 |

In Comparative Experiment 4, the amount of antiadhesive agent was finally set so low, at 0.015% by weight (of the 30% strength solution) of magnesium octanoate, that the pummel values after the standard autoclave process are now again within the desired range, namely 6 on the fire side and 5 on the tin side. However, the pummel value reduced to 1 on the fire side and 2.5 on the tin side after the long autoclave process, and 0 on the fire side and 1 on the tin side after the heat-aging. The result is a maximum Δ pummel value of 6, which is beyond the limits of acceptability.

Inventive Example 5 used an alternative organophosphite, namely Irgaphos® DDPP, its amount being 0.08% by weight. In all of the experiments, the resulting pummel values were very uniform, between 5 and 6.5, giving a maximum Δ pummel value of 1.5, a very good value for practical purposes.

Finally, Comparative Experiments 6 and 7 were carried out, using the plasticizer DHA, the addition of the antiadhesive agent being such as to give a pummel value of from 3 to 4 after the standard autoclave process. In comparison with the plasticizer 3G7, this requires considerably greater amounts of antiadhesive agent. In the Inventive Example 7, using 0.15% by weight addition of Alkanox® TNPP, all of the pummel values were very narrowly distributed within the prescribed scope, the resultant maximum Δ pummel value therefore being 1. Without the inventive addition of organophosphite, the pummel value reduces to values from 1.5 to −1, the resultant maximum Δ pummel value therefore being 4.

The invention is applied in the production of films for producing laminated safety glass, in particular for applications in he construction sector and automotive sector.

1. A film based on plasticized partially acetalized polyvinyl alcohol for use as intermediate layer in laminated safety glass, comprising
from 0.001 to 0.25% by weight, based on the entire film mixture, of one or more additives which reduce adhesion of the film to a glass surface, these having been selected from the group consisting of
magnesium salts of organic acids,
potassium salts of organic acids,
and an additive compensating for adhesion variations and comprising one or more phosphorus compounds selected from the group consisting of
organophosphites, i.e. esters of phosphorous acid with organic residues,
organophosphates, i.e. esters of orthophosphoric acid with organic residues,
where the amount added of the phosphorus compounds is such that
the pummel value, as defined in the description, of a laminated glass produced using the film as intermediate layer, after
the 90 min standard autoclave process,
after the 330 min long autoclave process, and—after heat-aging for 72 hours at 125° C.
is >_{—}1.5 and <_{—}8 on each of the two glass sides, and
the maximum A-pummel value, as defined in the description, is <_{—}2.5.

2. The film as claimed in claim 1, characterized in that the additive used which reduces adhesion of the film to a glass surface comprises magnesium 2-ethylhexanoate at a concentration of from 0.001 to 0.2% by weight, based on the entire film mixture.

3. The film as claimed in claim 2, characterized in that the plasticizer used comprises 3G8, 3G7, and/or DHA, and in that the amount used of the magnesium 2-ethylhexanoate is
from 0.01 to 0.1% by weight, if 3G8 is used as plasticizer,
from 0.005 to 0.05% by weight, if 3G7 is used as plasticizer
from 0.005 to 0.05% by weight, if DHA is used as plasticizer
an appropriate intermediate amount of magnesium 2ethylhexanoate, if use is made of a plasticizer mixture,
based in each case on the entire film mixture.

4. The film as claimed in claim 1 characterized in that the additive used compensating for adhesion variations comprises one or more phosphites from the group consisting of tris(nonylphenyl) phosphite, triphenyl phosphite and diphenyl octyl phosphite in a concentration of from 0.05 to 0.5% by weight.

5. The film as claimed in claim 1 characterized in that the additive used compensating for adhesion variations comprises tris(nonylphenyl) phosphite, triphenyl phosphite and/or diphenyl octyl phosphite in a concentration of from 0.1 to 0.2% by weight.

6. A laminate, encompassing at least one silicate glass layer, and also a film as claimed in claim 1.

7. The use of phosphorus compounds, selected from the group consisting of
organophosphites, i.e. esters of phosphorous acid with organic residues,
organophosphates, i.e. esters of orthophosphoric acid with organic residues, as additive compensating for the variations in adhesion during further processing, in films based on plasticized partially acetalated polyvinyl alcohol.
